(19) United States
(12) Patent Application Publication
(10) Pub. No.: US 2010/0052216 A1
(43) Pub. Date: Mar. 4, 2010

(54) NANO IMPRINT LITHOGRAPHY USING AN ELASTIC ROLLER

(76) Inventors: Yong Hyup Kim, Seoul (KR); DongKyun Seo, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/201,887

(22) Filed: Aug. 29, 2008

(51) Int. Cl. B29C 51/22

(52) U.S. Cl. 264/284; 425/374

(57) ABSTRACT

Imprint lithography devices and methods of lithography are provided.

### BACKGROUND

1. Field

The present disclosure relates generally to nanotechnology and, more particularly, to nano imprint lithography.

2. Description of Related Technology

Ultraviolet (UV) lithography process has been widely used to provide small patterns in production of integrated circuits. However, UV lithography has a limitation when it comes to producing nano-scale patterns due to the wave length of UV waves. Moreover, as photolithography techniques become more complicated, the cost of the required equipment increases. Thus, nano imprint lithography (NIL) is a promising alternative to UV lithography in that it provides a low cost and high throughput method of producing patterns. But NIL also has drawbacks in the pattern transfer process. One of the drawbacks is a limitation on the size of a mold. It is beneficial to use a mold large enough to cover the substrate and, therefore, enhance the productivity. However, it can be difficult to obtain uniform patterns with NIL under constant pressure when the mold is substantially large. When the mold has patterns with different heights, the patterns of the mold may not be thoroughly transferred to the substrate if a uniform pressure is not applied along the whole pattern.

### SUMMARY

Imprint lithography devices and methods of lithography are provided. In one embodiment, an imprint lithography device comprises a mold comprising a first and a second side, wherein the first side comprises a plurality of protrusions, a substrate comprising a first and a second side and configured to be brought into contact with the mold, wherein the first side of the substrate is configured to face the first side of the mold and applied with a soft or an imprintable layer, and an elastic roller configured to apply uniform pressure to the whole substrate by pressing the second side of the substrate with the elastic roller and moving the elastic roller and the substrate relative to each other, wherein pressing the substrate is configured to bend the substrate to make contact between the soft layer on the first side of the substrate and surfaces of the protrusions of the first side of the mold, and thereby generate imprints of the protrusions of the mold on the soft layer.

In one embodiment, a method of lithography comprises providing a mold comprising a first and a second side, wherein the first side comprises a plurality of protrusions, providing a substrate comprising a first and a second side, wherein the first side of the substrate is configured to face the first side of the mold and applied with a soft layer to be imprinted, applying pressure to the substrate by pressing the second side of the substrate with the elastic roller, imprinting the protrusions of the mold on the soft layer by bending the substrate with the applied pressure from the elastic roller and creating contact between the soft layer and surfaces of the protrusions on the first side of the mold, and moving the substrate and elastic roller relative to each other such that additional portion of the soft layer are imprinted by the mold.

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a schematic of an illustrative embodiment of a nano imprint lithography (NIL) device using an elastic roller.

FIG. 2 shows a schematic of an illustrative embodiment of an elastic roller used in NIL.

FIGS. 3A through 3C are schematic diagrams of an illustrative embodiment of a process of NIL using an elastic roller to imprint a pattern onto an imprintable layer.

FIG. 4 shows a schematic of an illustrative embodiment of a mold used in NIL using an elastic roller.

FIG. 5 shows a schematic of an illustrative embodiment of a pattern imprinted on an imprintable layer by a mold after NIL process using an elastic roller.

FIG. 6 shows a schematic of another illustrative embodiment of a NIL device using an elastic roller.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

Some embodiments provide an imprint lithography device comprising an elastic or flexible roller configured to apply substantially uniform pressure to an area in contact. When the elastic roller presses on a surface, the surface in contact is applied with a substantially uniform pressure by the gas within the elastic roller. In one embodiment, an imprint lithography device comprises a flexible roller, a substrate having a first side and a second side, wherein the second side is in contact with the flexible roller, an imprintable layer having a first side and a second side, wherein the first side is in contact with the first side of the substrate and a mold comprising a plurality of projections, wherein the projections extend into the second side of the imprintable layer, wherein a portion of each of the mold, imprintable layer and substrate extends beyond the flexible roller, and the substrate and the flexible roller are configured to move relative to each other, such that said portions can be moved to be in contact with the flexible roller. The projections can comprise dimensions of from about 1 nm to about 10 nm. In one embodiment the mold can be rigid and the substrate can be flexible. In another embodiment, the mold can be flexible and the substrate can be rigid.

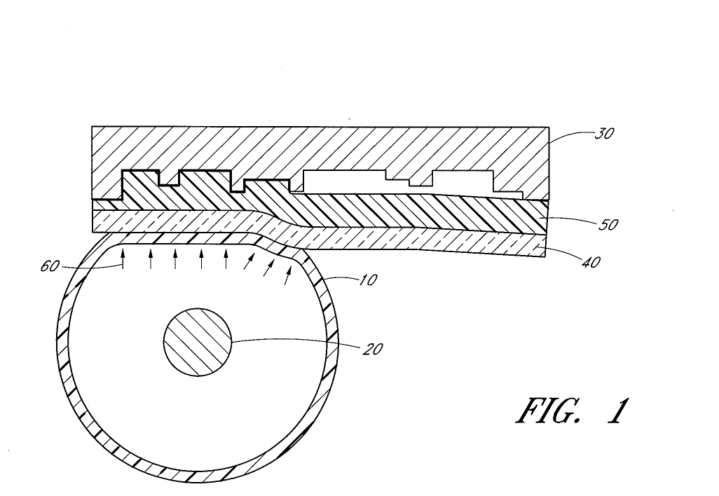

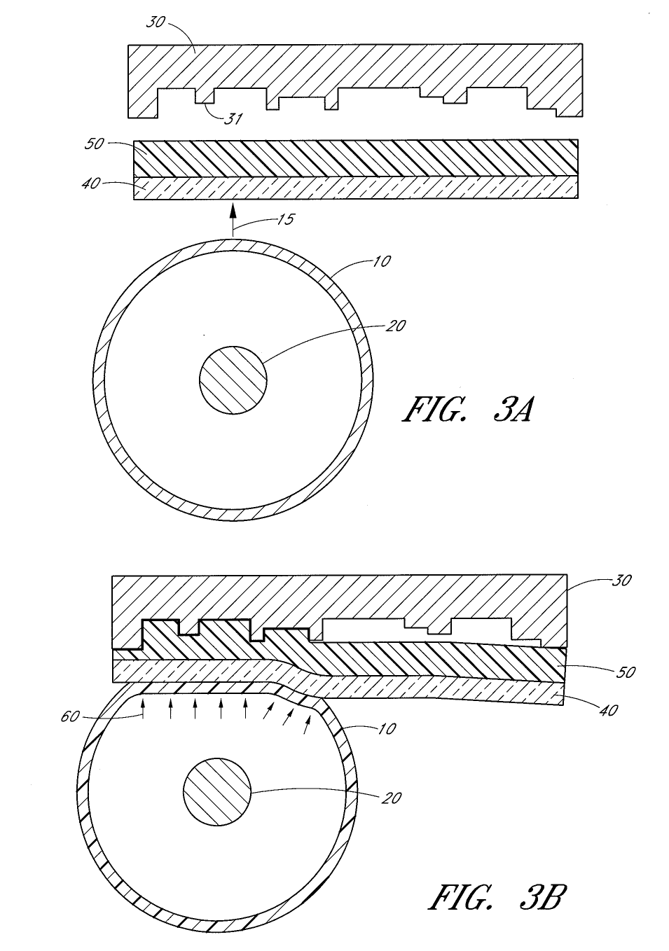

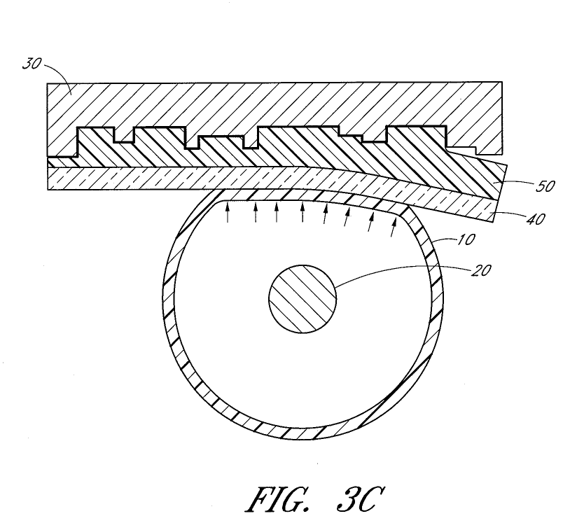

FIG. 1 shows a schematic of an illustrative embodiment of a nano imprint lithography (NIL) device using an elastic or flexible roller 10. As depicted, the NIL device includes a mold 30, a substrate 40, a soft or an imprintable layer 50, and the elastic or flexible roller 10. The substrate 40 can be applied with the imprintable layer 50. The mold 30 can include a first and a second side, where the first side comprises one or more protrusions (indicated by reference number 31 in FIG. 3A). These protrusions provide a pattern that can imprint the soft layer 50 during an imprinting process. The substrate 40 includes a first side and a second side, where the first side is the side that is facing the mold 30 and is applied with the soft layer 50. The second side of the substrate 40 is configured to be pressed by the elastic roller 10. The soft or imprintable layer 50 includes a first and a second side, where the first side is in contact with the first side of the substrate 40, and the second side is configured to be brought into contact with the protrusions on the first side of the mold 30. The imprintable layer 50 can be any material on which it is desired to imprint the pattern produced by the protrusions 31 on the mold 30. In some embodiments the imprintable layer 50 is a relatively flat, sheet-like material. The imprintable layer 50 can be formed of any of a wide range of materials, including, but not limited to, photo-polymers such as silicone epoxy, thermo-polymers such as benzyl methacrylate or cyclohexyl acrylate, metal foils, and paper. In certain embodiments, the imprintable layer 50 is used for a resist film and in these embodiments should be made of a material suitable for this purpose. The imprintable layer 50 can be applied as a liquid or in a gel state, or it can be applied as a flexible or elastic solid that is capable of being imprinted. If the imprintable layer 50 is applied as a liquid or gel, it can be cured after imprinting through exposure to appropriate energy such as heat or UV radiation. However, some materials can be cured simply by standing at room temperature, such as about 20° C.

FIG. 1 illustrates an embodiment of the NIL device where the mold 30 is rigid and the substrate 40 is flexible. While the material for the substrate 40 is not particularly limited, in the illustrative embodiment, the substrate 40 can be composed of flexible polymers, such as PET (PolyEthylene Terephthalate) material, PVC (PolyVinyl chloride), etc. The mold 30 can be composed of polymer protrusions on a plate, such as silicon wafer. In other embodiments, the mold 30 and the substrate 40 can be flexible, but the mold 30 is placed against a solid flat surface to limit bending of the mold 30. The elastic roller 10 is configured to be brought into contact with the second side of the substrate 40 and to apply uniform pressure 60 to an area contacting the substrate 40 by, for example, pressing on the substrate 40. Pressing on the substrate 40 with the elastic roller 10 can bend a portion the substrate 40 that is in contact with the elastic roller 10. The flexible substrate 40 bends to bring about contact with the mold 30 and the imprintable layer 50 as shown. The imprintable layer 50 that is in contact with the mold 30 can imprint the protrusions of the mold 30 onto the imprintable layer 50.

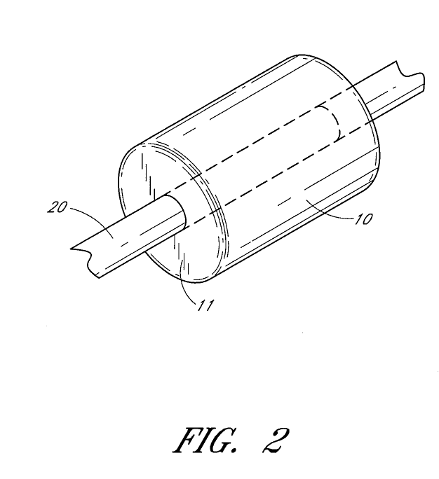

FIG. 2 shows a schematic of an illustrative embodiment of the elastic or flexible roller 10. The elastic roller 10 can be configured to apply a substantially uniform pressure to an area under contact. The shape of the elastic roller 10 is not particularly limited, but can be a cylindrical shape. The elastic roller 10 can move in a direction parallel to the substrate 40 (shown in FIG. 1) by rolling about an axis. The elastic roller 10 can comprise an outer balloon or elastic material 11 that is filled with a fluid, such as a gas, and configured to maintain a substantially constant internal pressure. In one embodiment, the outer balloon 11 can include durayl, arnitel, or etc. The elastic roller 10 can further include a roller device 20 embedded within the outer balloon 11. The roller device 20 can roll and propagate the elastic roller 10.

FIGS. 3A through 3C are schematic diagrams of an illustrative embodiment of a process of NIL using the elastic roller 10 to imprint a pattern onto the soft layer 50. As depicted in FIG. 3A, the elastic roller 10 may start out in a position in which it is not in contact with the substrate 40. In this position, no pressure is applied and protrusions or projections 31 of the mold 30 may not be imprinting onto the second side of the soft layer 50. The roller 10 can then be moved in a direction 15 to bring about contact with the second side of substrate 40. As depicted in FIG. 3B, the contact between the substrate 40 and the elastic roller 10 causes the substrate 40 to bend and apply substantially uniform pressure 60 in an area of contact. The pressure 60 applied by the elastic roller 10 onto the substrate 40 can be from about 5 Newtons (N) to about 150 Newtons, such as about 10 N to about 100 N. Nevertheless, in some particularly durable embodiments, higher amounts of pressure can be applied. The bending of the substrate 40 can cause subsequent bending of the soft layer 50 applied on the first side of the substrate 40. The bending of the substrate 40 and the soft layer 50 can cause contact between the second side of the soft layer 50 and the protrusions 31 on the first side of the mold 30. The protrusions 31 of the mold 30 can extend into the second side of the soft or imprintable layer 50 and imprint the protrusions 31 of the mold 30 onto the soft layer 50. In one embodiment, as shown in FIG. 3C, a portion of the mold 30, the imprintable layer 50, and the substrate 40 can extend beyond the elastic roller 10. In some embodiments, the elastic roller 10 and the flexible substrate 40 can move relative to each other and portions previously not pressed by the elastic roller 10 can be pressed during movement to create imprints. In one embodiment, the elastic roller 10 can be configured to move and press a portion of a surface previously not contacted. In order to imprint an entire surface of the soft layer 50, the substrate 40 and the elastic roller 10 can be configured to move relative to each other, such that the portions not in contact with the elastic roller 10 can be moved to come into contact with the elastic roller 10. With the relative motion between the substrate 40 and the elastic roller 10, a uniform and constant pressure 60 can be applied on the whole substrate 40 even when the substrate 40 and the mold 30 may be substantially large. The mold 30 can be large enough to cover the substrate 40 and enhance the productivity of imprinting process. Thus, the size of the mold 30 can be varied depending on the particular imprinting process desired. In one embodiment, the mold can comprise a width of from about 10 cm to about 15 cm, such as 1 cm to 10 cm, and a length of from about 1 cm to about 50 cm, such as 10 cm to 30 cm.

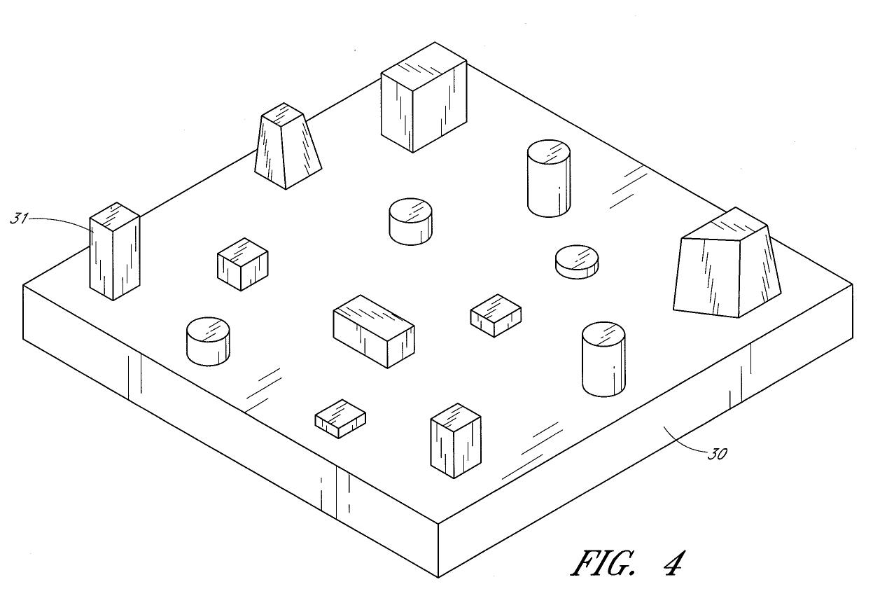

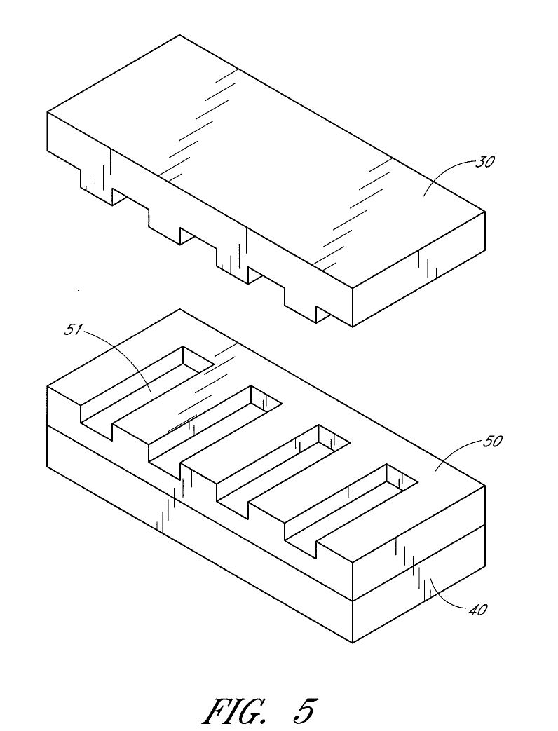

FIG. 4 shows a schematic of an illustrative embodiment of the mold 30 used in NIL using the elastic roller 10. The protrusions 31 on the mold 30 can include three-dimensional structures in which one or more dimensions are of at least from about 1 nm (nanometer) to about 1000 nanometers. In one embodiment, the protrusions 31 can have dimensions from about 1 nm to about 10 nm. The protrusions 31 can have a variety of shapes such as, circle, oval, and shape with three or more sides. The protrusions 31 can have varying cross-sections. The protrusions 31 can be of substantially the same or different heights.

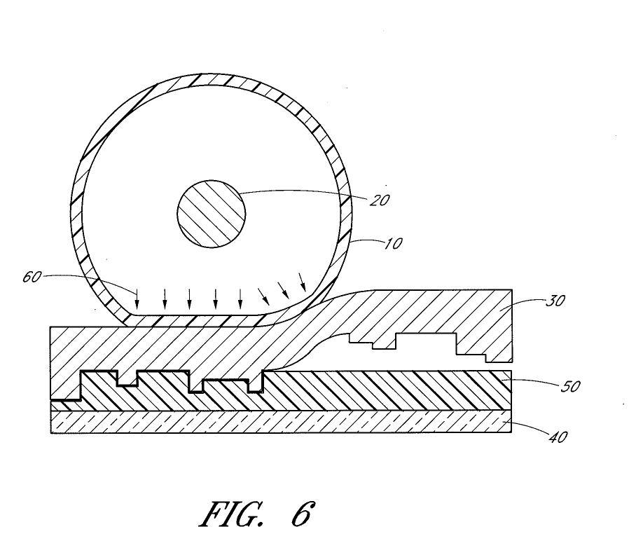

FIG. 5 shows a schematic of an illustrative embodiment of a pattern imprinted on the imprintable layer 50 by the mold 30 after NIL process using the elastic roller 10. The soft or imprintable layer 50 can include polymer material such as thermal curable resist, UV curable resist, or etc. As depicted, the imprintable layer 50 includes a plurality of imprints 51 created from the protrusions 31 (shown in FIG. 3A) of the mold 30. The imprints 51 will correspond to the size of the protrusions 31, and can include, for example, indentations with dimensions of at least from about 1 nm to about 1000 nm. In one embodiment, the imprints 51 can be from about 1 nm to 10 nm. The soft layer 50 having the desired imprints 51 can be used in fabrication for electrical, optical, photonic and biological devices. For electronics devices, the soft layer 50 can be used to fabricate MOSFET, O-TFT, electrical circuits, semiconductors, etc. For optics and photonics, the soft layer 50 can be used to fabricate subwavelength resonant grating filter, polarizers, waveplate, anti-reflective structures, integrated photonics circuit, plasmontic devices, display devices, etc. For biological devices, the soft later 50 can be used to make sub-10 nm nanofluidic channels, biosensors, etc.

FIG. 6 shows a schematic of another illustrative embodiment of a NIL device using an elastic roller. In this embodiment, the mold 30 can be flexible and the substrate 40 can be rigid. The mold 30 can comprise flexible polymers, such as PDMS (Polydimethylsiloxane), PET, PVC, etc. The substrate 40 can comprise flat plates, such as a silicon wafer. In other embodiments, the mold 30 and the substrate 40 can be flexible, but the substrate 40 is placed against a solid flat surface to limit bending of the substrate 40. When the mold 30 is flexible, the moving of the elastic roller 10 can include applying pressure 60 to the whole mold 30 by pressing the mold 30 with the elastic roller 10, imprinting the protrusions of the mold 30 on the soft layer 50 by bending the mold 30 with the pressure 60 applied from the elastic roller 10 and creating contact between the soft layer 50 and surfaces of the protrusions 31 of the mold 30, and moving the mold 30 and elastic roller 10 relative to each other such that additional portion of the soft layer 50 are imprinted by the mold 30.

As depicted in FIG. 6, the mold 30 can include the first and the second side, wherein the first side comprises a plurality of protrusions 31 (in FIG. 3A). The second side of the mold 30 is configured to be pressed by the elastic roller 10. The protrusions 31 can imprint the soft layer 50 when they are brought into contact. The substrate 40 includes the first side and the second side, wherein the first side is facing the mold 30 and applied with the soft layer 50. The soft or imprintable layer 50 includes the first and the second side, wherein the first side is in contact with the first side of the substrate 40 and the second side is configured to be brought into contact with the protrusions on the first side of the mold 30. The elastic roller 10 is configured to be brought into contact with the second side of the mold 30 and apply uniform pressure 60 to an area contacting the mold 30 by pressing on the substrate 40. The contact between the mold 30 and the elastic roller 10 can create bending of the mold 30. The bending of the mold 30 can create contact between the second side of the soft layer 50 and the protrusions 31 on the first side of the mold 30. The protrusions 31 of the mold 30 can extend into the second side of the soft or imprintable layer 50 and imprint the protrusions 31 of the mold 30 onto the soft layer 50. In one embodiment a portion of the mold 30, the imprintable layer 50, and the substrate 40 can extend beyond the elastic roller 10. In order to imprint an entire surface of the soft layer 50, the mold 30 and the elastic roller 10 can be configured to move relative to each other, such that the portions not contacted with the elastic roller 10 can be moved to be in contact with the elastic roller 10. With the relative motion between the mold 30 and the elastic roller 10, a uniform and constant pressure 60 can be applied on the whole mold 30 even when the substrate 40 and the mold 30 may be substantially large.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An imprint lithography device, the device comprising:
a mold comprising a first and a second side, wherein the first side comprises a plurality of protrusions;
a substrate comprising a first and a second side and configured to be brought into contact with the mold, wherein the first side of the substrate is configured to face the first side of the mold and applied with a soft layer; and
an elastic roller configured to apply uniform pressure to the whole substrate by pressing the second side of the substrate with the elastic roller and moving the elastic roller and the substrate relative to each other, wherein pressing the substrate is configured to bend the substrate to make contact between the soft layer on the first side of the substrate and surfaces of the protrusions of the first side of the mold, and thereby generate imprints of the protrusions of the mold on the soft layer;
wherein the elastic roller comprises an outer balloon filled with gas and configured to maintain constant internal pressure.

2. The imprint lithography device of claim 1, wherein the elastic roller comprises a cylindrical shape and is configured to move in a direction parallel to the substrate by rolling about an axis.

3. (canceled)

4. The imprint lithography device of claim 1, wherein the elastic roller further comprises a roller device embedded within the balloon.

5. The imprint lithography device of claim 1, wherein the balloon comprises an acrylic or elastomer.

6. The imprint lithography device of claim 1, wherein the mold comprises a width of about 10 cm and a length of from about 10 cm to about 50 cm.

7. The imprint lithography device of claim 6, wherein the protrusions of the mold comprises three-dimensional nanostructures with dimensions of at least from about 1 nanometer to about 10 nanometers.

8. The imprint lithography device of claim 1, wherein the pressure applied by the elastic roller on the substrate is at most about 100 Newtons.

9. The imprint lithography device of claim 1, wherein the soft layer comprises polymer materials such as thermal curable resist, or UV curable resist.

10. The imprint lithography device of claim 1, wherein imprints of the protrusions of the mold on the soft layer comprises indentations with dimensions of at least from about 1 nanometer to about 10 nanometers.

11. The imprint lithography device of claim 1, wherein the mold is configured to be rigid and the substrate is configured to be flexible.

12. The imprint lithography device of claim 1, wherein the substrate comprises a PET material.

13. The imprint lithography device of claim 1, wherein the mold is configured to be flexible and the substrate is configured to be rigid.

14. The imprint lithography device of claim 13, wherein the mold comprises a PDMS material.

15. The imprint lithography device of claim 13, wherein the elastic roller is configured to apply uniform pressure to the whole mold by pressing the second side of the mold with the elastic roller and moving the elastic roller and the mold relative to each other, wherein pressing the mold is configured to bend the mold to make contact between surfaces of the protrusions of the first side of the mold and the soft layer on the first side of the substrate, and thereby generate imprints of the protrusions of the mold on the soft layer.

16. A method of lithography using imprinting, the method comprising:
providing a mold comprising a first and a second side, wherein the first side comprises a plurality of protrusions;
providing a substrate comprising a first and a second side, wherein the first side of the substrate is configured to face the first side of the mold and applied with a soft layer to be imprinted;
applying pressure to the substrate by pressing the second side of the substrate with the elastic roller; imprinting the protrusions of the mold on the soft layer by bending the substrate with the applied pressure from the elastic roller and creating contact between the soft layer and surfaces of the protrusions on the first side of the mold; and
moving the substrate and elastic roller relative to each other such that additional portion of the soft layer are imprinted by the mold;
wherein the elastic roller comprises an outer balloon filled with gas and configured to maintain a constant internal pressure.

17. (canceled)

18. The method of claim 16, wherein the mold is configured to be rigid and the substrate is configured to be flexible.

19. The method of claim 16, wherein the mold is configured to be flexible, and the substrate is configured to be rigid.

20. The method of claim 19, wherein the moving the substrate further comprises:
applying pressure to the whole mold by pressing the second side of the mold with the elastic roller;
imprinting the protrusions of the mold on the soft layer by bending the mold with the pressure applied from the elastic roller and creating contact between the soft layer and surfaces of the protrusions of the mold; and
moving the mold and elastic roller relative to each other such that additional portion of the soft layer are imprinted by the mold.

21. The method of claim 16, wherein the method is used in fabrication of semiconductors and display devices.

22. An imprint lithography device, comprising:
a flexible roller;
a substrate having a first side and a second side, wherein the second side is in contact with the flexible roller;
an imprintable layer having a first side and a second side, wherein the first side is in contact with the first side of the substrate; and
a mold comprising a plurality of projections, wherein the projections extend into the second side of the imprintable layer, wherein a portion of each of the mold, imprintable layer and substrate extends beyond the flexible roller, and the substrate and the flexible roller are configured to move relative to each other, such that said portions can be moved to be in contact with the flexible roller;
wherein the flexible roller comprises an outer balloon filled with gas and configured to maintain a constant internal pressure.

23. The imprint lithography device of claim 22, wherein the projections comprises dimensions of from about 1 nm to about 10 nm.

24. The imprint lithography device of claim 22, wherein the mold is configured to be rigid and the substrate is configured to be flexible.

25. The imprint lithography device of claim 22, wherein the mold is configured to be flexible and the substrate is configured to be rigid.
